(19) United States
(12) Patent Application Publication
(10) Pub. No.: US 2025/0128595 A1
(43) Pub. Date: Apr. 24, 2025

(54) COUPLING DEVICE FOR A DIFFERENTIAL OF A MOTOR VEHICLE

(71) Applicant: ZF FRIEDRICHSHAFEN AG, Friedrichshafen (DE)

(72) Inventors: Kim FÜHRER, Lindau (DE); Philipp EDER, Mauth (DE); Benedikt MAIERHOFER, Vilshofen an der Donau (DE); Alois BÖCK, Hutthurm (DE); Matthias WINKEL, Weingarten (DE)

(21) Appl. No.: 18/684,953

(22) PCT Filed: Aug. 25, 2022
(86) PCT No.: PCT/EP2022/073647

§ 371 Date: Feb. 20, 2024

(30) Foreign Application Priority Data
Aug. 26, 2021 (DE) 10 2021 209 356.6

(51) Int. Cl. B60K 17/02; B60K 17/35; F16H 48/08

(52) U.S. Cl. CPC B60K 17/02; B60K 17/35; F16H 48/08

(57) ABSTRACT

Coupling device for a differential of a motor vehicle, which differential has a drive gear and an inner differential carrier which at least partially surrounds at least one bevel differential side gear and at least one bevel differential pinion gear. An actuating device is configured to move coupler into a coupling state by the actuating device to couple the inner differential carrier with the drive gear and to move the coupler into a decoupling state by the actuating device to decouple the inner differential carrier from the drive gear. The actuating device has transmission element adapted to transmit an actuating force applied to the transmission element by an actuator to the coupler for carrying out a coupling movement and/or uncoupling movement of the coupler. The transmission element is connectable or is connected to the coupler by a bayonet closure.

### CROSS REFERENCE TO RELATED APPLICATIONS

This is a U.S. national stage of Application No. PCT/EP2022/073647 filed Aug. 25, 2022. Priority is claimed on German Application No. DE 10 2021 209 356.6 filed Aug. 26, 2021, the content of which is incorporated herein by reference.

### BACKGROUND OF THE INVENTION

### 1. Field of the Invention

The disclosure is directed to a coupling device for a differential of a motor vehicle, which differential has a drive gear and an inner differential carrier that at least partially surrounds at least one bevel differential side gear and at least one bevel differential pinion gear. An actuating device is configured to move a coupler, particularly a sliding sleeve, into a coupling state by the actuating device in order to couple the inner differential carrier with the drive gear and to move the coupler into a decoupling state by the actuating device in order to decouple the inner differential carrier from the drive gear.

### 2. Description of the Related Art

Coupling devices for differentials of motor vehicles, which are configured to detachably couple an input side of the differential, particularly a drive gear of the differential, with an output side of the differential, particularly an inner differential carrier, are known in principle from the prior art. For example, such coupling devices are used to decouple an axle of a motor vehicle from the rest of the drivetrain or to drive the axle, for example, to switch the axle on and off as needed.

To this end, it is further known, particularly for reducing wear in driving conditions in which the axle need not be driven, that a decoupling can be carried out in order to reduce the driven components of the drivetrain, in particular to prevent the axle from being driven along or carried along unnecessarily. For this purpose, the decoupling point or also the switching point is preferably located as close as possible to the driveshaft. In this respect, it is further known that corresponding actuating devices that are configured to bring the coupler into different coupling states at least temporarily contact the coupler in order to move the coupler, for example, into the coupling state or into the decoupling state.

### SUMMARY OF THE INVENTION

It is an object of one aspect of the invention to provide an improved coupling device for a differential of a motor vehicle in which, in particular, the quantity of component parts can be reduced and assembly can be facilitated.

One aspect of the invention is directed to a coupling device for a differential of a motor vehicle. The differential has a drive gear and an inner differential carrier. The inner differential carrier at least partially surrounds a bevel differential side gear and at least one bevel differential pinion gear, commonly two bevel differential side gears and two bevel differential pinion gears. The coupling device has an actuating device in order to move a coupler into a coupling state and into a decoupling state. In the coupling state, the inner differential carrier is coupled with the drive gear and in the decoupling state the inner differential carrier is decoupled or disconnected from the drive gear. The actuating device accordingly makes possible a selective coupling and decoupling between drive gear and inner differential carrier. Accordingly, it is ultimately a matter of whether the axle or wheels, respectively, which are associated with the differential are coupled with the rest of the drivetrain via the bevel differential side gear, bevel differential pinion gear and drive gear or whether the coupling is canceled by decoupling the inner differential carrier from the drive gear.

The invention is predicated on the insight that the actuating device comprises transmission elements adapted to transmit an actuating force applied to the transmission elements by an actuator to the coupler for carrying out a coupling movement and/or uncoupling movement of the coupler. The transmission elements are connectable or are connected to the coupler by a bayonet closure. By “bayonet closure” is meant a connection of the transmission elements to the coupler through a defined connection movement of these two elements relative to one another in the manner of a bayonet connection. To this end, the connection movement can be configured or carried out in such a way that a preferably predominantly linear, particularly preferably exclusively linear, joining of the transmission element and coupler-plug-in movement—is carried out in a first movement portion, and a preferably predominantly rotational, particularly preferably exclusively rotational, relative movement of the transmission elements and coupler is carried out in a second movement portion taking place after the first movement portion (closure movement). For example, in a first step, the transmission elements and coupler can be oriented coaxial to one another and can be pushed together or put together linearly along the common axis. As distinguished from a screw connection, the present bayonet connection can carry out at least one movement portion with a purely linear relative movement (that is, without rotational movement components) of the two mating members and, in a further movement portion, can carry out a purely rotational relative movement (without linear movement components) of the two mating members.

Carrying out the connection of the transmission elements and coupler in the manner of a bayonet connection can reduce the quantity of required component parts, particularly the quantity of required fasteners in the form of separate elements. Assembly and disassembly can also be facilitated because it is no longer necessary to apply a tool for fixing any fasteners. Finally, the overall weight of the coupling device can be reduced by a bayonet connection.

The actuating device can be configured, for example, to move the coupler out of the coupling state into the decoupling state by a shift paddle. The shift paddle is adjusted in the coupling state without contacting the coupler. Alternatively, this principle may also be reversed, i.e., the coupler are moved out of the decoupling state by the shift paddle. In so doing, the shift paddle can preferably be adjusted in the decoupling state without contacting the coupler. The shift paddle can be formed, for example, as a swivelably or rotatably supported element. The at least partial noncontact of the shift paddle with the coupler may result in that relative movements occurring between the coupler and switching device do not lead to wear or friction, since there is no contact between the coupler and the switching device, particularly the shift paddle. Within the meaning of the present application, the term “contact-free” encompasses both a direct contact by way of two contact surfaces abutting one another directly or via transmission element or a pressure piece by which the shift paddle acts on the coupler.

The coupling device can be adapted in such a way that the drive gear is arranged at an outer differential carrier such that the coupling device can ultimately produce or undo the coupling between the drive gear, which is coupled with the outer differential carrier, and the inner differential carrier. The inner differential carrier may also be referred to as pinion gear carrier. The coupler are constructed as a separate component part which is detachably or non-detachably connected to the transmission element in the manner of a bayonet connection. Accordingly, it is possible that once the bayonet connection is connected by frictionally engaging and/or positively engaging and/or bonding (e.g., glue) connection elements, the end position of the transmission element/coupler connection by the bayonet connection can no longer be detached without destroying it. For example, a snap action latching connection is formed which is effective particularly when the end position of the bayonet connection is reached and which breaks during an opening movement or entirely prevents an opening movement. Alternatively, the bayonet connection can be configured in such a way that it is possible to detach the transmission elements and coupler without destroying them. It may prove advantageous when a mechanical resistance must be overcome during an opening movement so that an opening movement carried out with little force does not result in an opening of the bayonet connection.

With the actuator, in particular with a shift paddle operatively communicating with an actuator, a movement of the coupler can be initiated, as a result of which the coupler are moved, particularly the coupler are moved out of the coupling state into the decoupling state. It is possible that the actuator is configured to move the transmission elements, particularly parallel to a rotational axis of the drive gear and/or parallel to a rotational axis of the inner differential carrier, in order to move the coupler into the decoupling state and/or into the coupling state. The engagement movement and/or disengagement movement of the transmission elements taking place parallel to the rotational axis of the drive gear and/or parallel to the rotational axis of the inner differential carrier can be carried out, for example, through a continuous contact of the transmission elements with the drive gear. Consequently, the position of the transmission elements is determined by contact with the drive gear in every intended state.

The actuating device or individual component parts of the actuating device can be supported on the input side or so as to be fixed with respect to the housing, for example, connected to the outer differential carrier and/or the drive gear, so that the actuating device as a whole, or at least component parts of the actuating device, can be at a standstill in the decoupling state. Through operation of the motor vehicle, the output side can have any rotational speed that does not lead to a movement of the drive gear and, accordingly, does not lead to a movement of the actuating device because of the decoupling between the inner differential carrier and the drive gear.

The transmission elements can have, for example, an annular portion and an engaging part which particularly extends at right angles to a main extension plane of the annular portion. The engaging part has at its end region remote of the annular portion, particularly at its distal end, a contact region for contacting the coupler. The annular portion can face the actuator so that the actuator carries out a movement of the coupler relative to the drive gear directly or with the intermediary of bridging elements, e.g., a shift paddle. The engaging part can comprise engaging elements, e.g., particularly finger-like engaging elements, or at least partially comprises engaging this type, which reach through openings of the outer differential carrier arranged between the coupler and the actuator.

The coupler can have, for example, a receiving portion in which or at which the contact region on the engaging part side is received and/or receivable. For example, the receiving portion can be formed as a receiving recess. The receiving recess has a plug-in region for the insertion of the engaging part-side contact region and a closure region for receiving the engaging part-side contact region in a frictionally engaging and/or positively engaging manner. In other words, the coupler have a closure region in the form of recesses in which engaging elements, particularly finger-like engaging elements, of the transmission elements engage in the final assembly condition. The bayonet connection of the transmission elements and coupler is produced in that the contact region on the engaging part side engages with or is received in or at the closure region on the coupler side.

The plug-in region and the closure region can preferably be arranged or formed adjacent to one another. The minimum distance of the plug-in region from a center of the coupler is greater than or equal to the minimum distance of the closure region from the center of the coupler, and/or the maximum distance of the plug-in region from the center of the coupler is greater than or equal to the maximum distance of the closure region from the center of the coupler. The center of the coupler can coincide with the rotational axis of the coupler in intended operation. A movement of the contact region on the engaging part side or on the transmission element side into the closure region on the coupler side can be achieved through a relative movement of the transmission elements and coupler in that the plug-in region and the closure region are arranged directly adjacent to one another.

The coupler can be formed, for example, in a disk-shaped and/or ring-shaped manner. A toothing is arranged or formed at an outer lateral surface of the coupler for engaging with a drive gear and/or a toothing is arranged or formed at an inner lateral surface of the coupler for engaging with the inner differential carrier. Accordingly, in the coupled state, the coupler can be placed between the drive gear and inner differential carrier in such a way that there is a torque-transmitting connection of the drive gear with the coupler via the outer lateral surface and there is a torque-transmitting connection of the coupler with the inner differential carrier via the inner lateral surface. By forming the coupler in an annular disk-shaped manner, for example, at least a component part of the bevel differential side gear and/or of the bevel differential pinion gear and/or of a shaft fitted to the differential can be received in an interior space of the coupler so that a compact construction of the coupling device itself and/or together with adjacent assemblies of the coupling device can be achieved.

The contact region of the transmission-side engaging part can have, for example, a protuberance which abuts a surface of the coupler remote of the actuator in the final assembly condition.

The transmission element can comprise, for example, (a) at least two engaging elements, particularly at least three engaging elements, and/or (b) the coupler can comprise, for example, at least two receiving recesses, particularly at least three receiving recesses, which are formed rotationally symmetrically, particularly so as to have an N-fold rotational symmetry. “N-fold rotational symmetry” can be understood to mean that the object rotated by defined angles coincides with the initial geometry prior to rotation on the rotated image.

It is possible that the contact region of the engaging part of the transmission element has a protuberance which abuts a surface of the coupler remote of the actuator in the final assembly condition. In other words, the engaging part has a groove-like recess which has a side wall at least at the side remote of the actuator, which sidewall abuts a surface of the coupler extending predominantly, particularly exactly, perpendicular to the rotational axis. The portion of the transmission element protruding over the main extension volume of the coupler at the side of the coupler remote of the actuator can be connected in a positively engaging and/or frictionally engaging manner with a blocking element with respect to a rotation relative to the coupler.

The contact region of the engaging part is preferably formed in the manner of a groove, particularly a groove having a rectangular basic shape. This means, for example, that the groove is formed in such a way that the two walls bounding the groove along the rotational axis can be formed parallel to one another. Alternatively or additionally, at least one wall boundary of a groove-like recess of the contact region of the transmission element can serve as a stop, in particular as a planar connection region, between the transmission element and the coupler. In a particularly preferable manner, the coupler can be acted upon by a spring unit and can be pressed against this stop of the contact region of the transmission element by the spring unit. Consequently, the connection of the transmission element to the coupler can accordingly be acted upon by a spring force and the risk of a detachment of this connection and/or a relative movement between the transmission element and the coupler due to the occurring friction force can be prevented.

The annular portion and the engaging part, particularly the annular portion and the protuberance of the engaging part, can be formed in one piece, for example. In other words, the annular portion and the engaging part of the transmission element are formed as an integral and, therefore, one-piece component part. It can be produced, e.g., as a cast component in a casting process or as a component part obtaining at least its basic shape in an additive manufacturing process. Due to the one-piece construction of the transmission element, the weight of the transmission element and any assembly expenditures for providing a subassembly are reduced.

The actuating device can have, for example, a spring unit which is configured to transmit an engaging force or a disengaging force to the coupler. The spring unit can preferably be formed to act against a decoupling movement generated by an actuator or to support a coupling movement actively or passively initiated by the actuator. The actuating device can be formed, for example, to preload the spring element during a movement of the coupler into the decoupling state.

A tilting of the transmission element relative to the inner differential carrier and/or relative to the outer differential carrier and/or relative to the drive gear can take place at least partially through the contact of the transmission element with the drive gear and/or at least partially through a spring unit which applies spring force to the transmission element.

The movement conveyed to the coupler by the actuator via the transmission element can be carried out, for example, against a spring force transmitted, in particular directly transmitted, to the coupler by a spring unit. The movement can comprise an engaging movement and/or a disengaging movement. This spring force can be utilized to ensure a defined position of the coupler. The spring force can also be used in such a way that, in an engaging movement, the coupler can carry this out solely through removal of an actuator-side pressure force and, therefore, through the spring force. Alternatively, the spring unit can be formed in such a way that exclusively the decoupling movement, i.e., the disengaging movement, is carried out in the absence of an actuator-side actuating force through the spring unit-side spring force.

The transmission element and the coupler can be configured, for example, to move the coupler from the coupling state to the decoupling state by a shift paddle, which shift paddle is positioned in the coupling state in a contact-free manner relative to the coupler.

It is possible that the spring unit is arranged or arrangeable in such a way that the spring unit prevents or impedes a relative movement between the coupler and the transmission element, particularly, by the spring unit, produces a frictionally engaging and/or positively engaging connection or connection components between the coupler and the transmission element. As has been stated above, this can be achieved, for example, in that a spring force of the spring unit acts on the coupler and/or the transmission element in such a way that they are pressed against one another and a friction effect is accordingly generated so that there is an increased resistance for a relative movement of the coupler and transmission element. Alternatively or in addition, the spring unit can be connected to the inner differential carrier so as to be fixed with respect to rotation relative to it (e.g., via a positive engagement) by a contact portion and simultaneously forms an end position limit (e.g., a stop) for a portion of the transmission element so that a movement is inhibited, particularly by positive engagement, at least in a relative rotational direction of the transmission element and coupler. For example, the spring unit has two spring carriers which are oriented parallel to one another and receive and/or support spring elements therebetween. For example, the spring carriers are formed as annular members which receive therebetween spring elements which are particularly distributed rotationally symmetrically and/or equidistant from one another over the annular shape. Accordingly, it is possible that two spring carriers which are formed in particular as sheet-metal component are oriented parallel to one another and have spring elements therebetween. These spring elements can be formed and/or arranged in such a way that the spring action thereof at least predominantly occurs at right angles to the main extension plane of the spring carriers. In other words, for example, coil springs can be used as spring elements, and the longitudinal axis of the coil springs is oriented at an angle of from 75° to 105°, preferably at an angle of from 85° to 95°, relative to the main extension plane.

The actuating device, in particular the coupler and the spring unit, can be arranged at least partially inside of the drive gear, for example. Accordingly, the actuating device, in particular the coupler and/or the spring element can be arranged, e.g., at least partially, preferably predominantly, particularly preferably completely, inside of the drive gear. By “inside of the drive gear” is meant herein that the outer boundary of the drive gear describes a volume (main extension volume) inside of which the coupler and/or the spring element are/is received at least partially, preferably predominantly, particularly preferably completely. A compact construction of the coupling device can be achieved in this way.

In addition to the coupling device, the invention is also directed to a method for assembling a coupling device described herein. This method comprises the following method steps: (a) putting together the transmission element and the coupler; (b) carrying out a relative rotational movement of the transmission element and coupler to bring about a positively engaging connection after putting them together. In doing so, there is first carried out the putting together, particularly the exclusively linear putting together, of the transmission element and coupler and, in a subsequent method step, a relative rotational movement, particularly an exclusively rotational relative rotational movement, of the transmission element and coupler is carried out. In a preferred embodiment form, the transmission element, in particular the engaging the transmission element, can be at least partially guided through openings of the outer differential carrier in a method step arranged prior to the connection with the coupler. Subsequently, the transmission element and coupler can be connected and a relative rotation of the transmission element and coupler can then be carried out to form the bayonet connection. A spring unit can subsequently be fitted in such a way that the spring unit applies a spring force to the coupler. As a result of applying spring force to the coupler, a force component acts between the coupler and the transmission element, which force component impedes or excludes a relative movement of the coupler and transmission element. Alternatively or in addition, after producing the bayonet connection between the coupler and transmission element, the spring unit can be arranged or formed so as to be fixed with respect to rotation relative to the transmission element and the coupler, i.e., so as to prevent rotation, in such a way that a “return” rotational movement of the transmission element and coupler opening the bayonet connection is prevented by the shaping of the spring unit. After the spring unit is fitted to the coupler and/or transmission element, particularly so as to make direct contact, an outer differential receptacle can be fitted to the drive gear, and the outer differential receptacle fixes the spring unit relative to the drive gear at least in a movement direction along the rotational axis of the drive gear. The outer differential carrier and/or the outer differential receptacle can be connected to the drive gear by bonding engagement, in particular by a weld connection.

The invention can also relate to a transmission device, particularly a transmission device comprising a differential, which has a coupling device described herein. Lastly, the invention can be directed to a motor vehicle which comprises a transmission device described herein.

All of the advantages, details, constructions and/or features of the coupling device according to the invention are transferable or are to be applied to the method according to the invention and to the transmission device according to the invention and to the vehicle according to the invention.

### BRIEF DESCRIPTION OF THE DRAWINGS

The invention is described in more detail with reference to embodiment examples in the drawings. The drawings show:

FIG. 1 is a schematic sectional view of a transmission device with a coupling device in a coupling state;

FIG. 2 is a schematic sectional view of a transmission device with a coupling device in a decoupling state;

FIGS. 3A-31 are perspective schematic views of the coupling device in various states of construction during an assembly;

FIG. 4 is a perspective schematic view of a spring unit of the coupling device; and

FIG. 5 is a detailed schematic view of the mounting situation of the spring unit with respect to the coupler.

### DETAILED DESCRIPTION OF THE PRESENTLY PREFERRED EMBODIMENTS

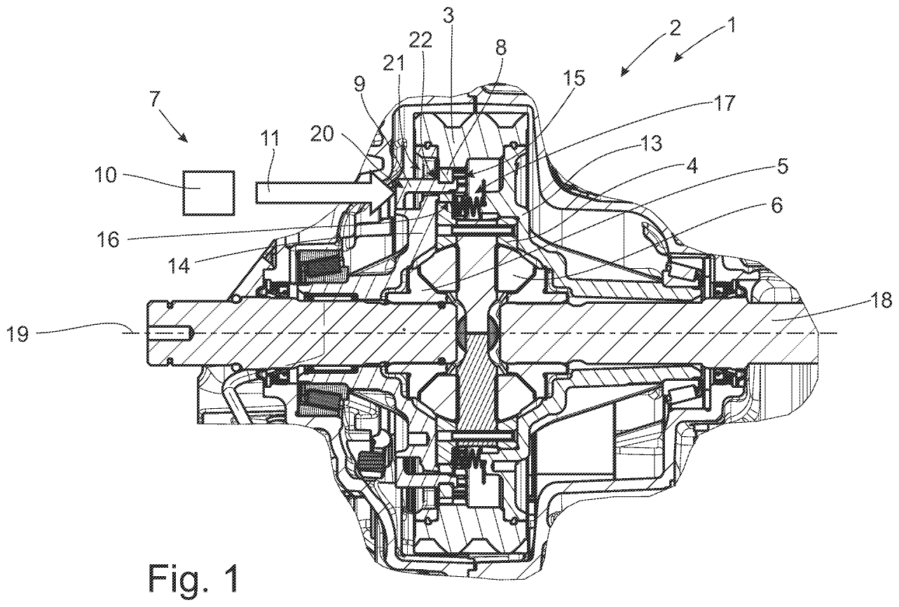

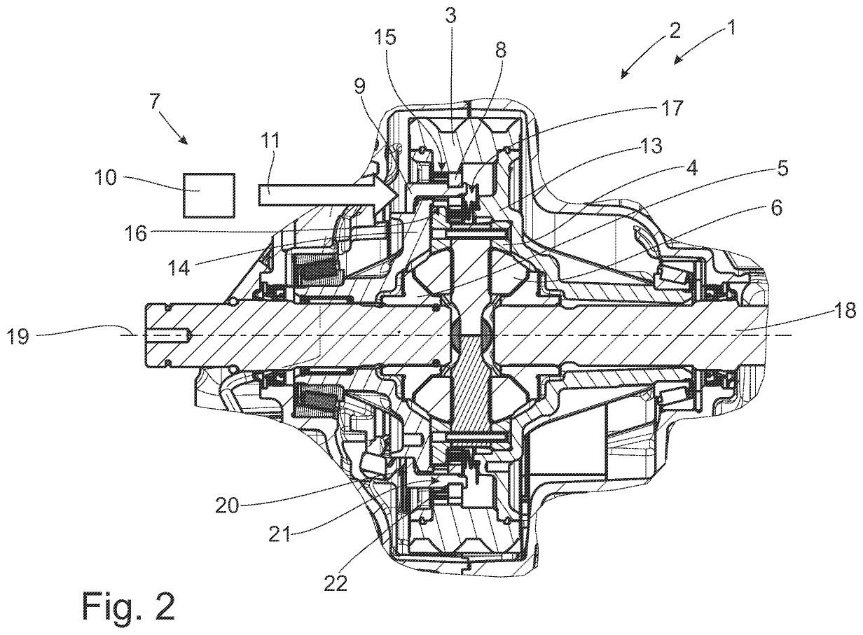

FIGS. 1 and 2 show the two intended switching states of the transmission device 1 and, therefore, also of the coupling device 2 for a motor vehicle, not shown in more detail, particularly a section of a differential. The transmission device 1 has a coupling device 2 which has a drive gear 3 and an inner differential carrier 4 which at least partially surrounds at least one bevel differential side gear 5 and at least one bevel differential pinion gear 6.

Further, the coupling device 2 comprises an actuating device 7 configured to move coupler 8, particularly a sliding sleeve, by the actuating device 7 into a coupling state and/or a decoupling state. The coupling state is shown in FIG. 1 and the decoupling state is shown in FIG. 2.

In the coupling state, the inner differential carrier 4 is coupled with the drive gear 3. The decoupling state can be occupied in a corresponding manner to decouple the inner differential carrier 4 from the drive gear 3. In order to move the coupler 8, the actuating device 7 can have, for example, a shift paddle (not shown) which can be moved by an actuator 10. To this end, the shift paddle can have a toothing portion, particularly a toothed wheel segment, which meshes with an output of the actuator 10. As an alternative to a shift paddle, the actuator 10 can act directly on transmission element 9 of the actuating device 7. The shift paddle can also act, particularly directly, on transmission element 9 described herein. An actuating force 11 and, accordingly, an actuating movement is transmitted to the transmission element 9 through the actuator 10 and to the coupler 8 by the transmission element 9. The actuating force 11 or actuating movement is shown schematically by the arrow 11.

The coupling state, the decoupling state and the changeovers between coupling state and decoupling state will be described in the following. As has been described, there is a contact between the coupler 8 and the inner differential carrier 4 in the decoupling state. The coupler 8 can be brought into the decoupling state, for example, via transmission element 9, for example, via transmission element 9 which are formed in this embodiment example as a pressure piece which may be constructed in the form of a pressure disk. To this end, an actuating force or pressing force 11 is applied to the pressure disk, i.e., the transmission element 9, by the actuator 10 and the transmission element 9 are accordingly moved parallel to and/or along the rotational axis 19 of the drive gear 3. This movement of the transmission element 9, particularly in direction of arrow 11, leads to a corresponding movement of the coupler 8 so that there is no longer any contact between the coupler 8 and the inner differential carrier 4 and, accordingly, there is no longer any torque transmission between the drive gear 3 and the inner differential carrier 4 (cf. FIG. 2). In the coupling state, the coupler 8 connect the drive gear 3, particularly an outer differential carrier 14 connected to the drive gear 3, to the inner differential carrier 4 as has already been described. In the depicted embodiment example, an inner toothing 15 of the drive gear 3 or of the outer differential carrier 14 and an outer toothing 16 of the inner differential carrier 4 are therefore not engaged in the decoupling state (cf. FIG. 2).

The actuating device 7 can have, for example, a spring unit 17, which is preloaded at least in the decoupling state shown in FIG. 2, i.e., the spring unit 17 exerts a spring force or a restoring force on the coupler 8 which brings the coupler 8 into the coupling state in the absence of actuation. It can also be provided that the spring unit 17 applies a spring force to the coupler 8 in every operating state of the coupler 8, and the spring force acting on the coupler 8 can be greater in the decoupling state than in the coupling state. Accordingly, when changing from the decoupling state shown in FIG. 2 to the coupling state shown in FIG. 1, the actuator 10 causes a movement of the transmission element 9 opposite the direction of arrow 11 in that it supports the transmission element 9 to a lesser extent against the spring force. Consequently, the pressure piece or transmission element 9 and, therefore, also coupler 8 are moved away so that the spring force of the spring unit 17 can be reduced and the coupler 8 are moved into the coupling state by the spring unit 17. Alternatively or additionally, it can be provided that a tractive force (acting opposite the direction of arrow 11) can be applied to the transmission element 9 by the actuator 10 and, therefore, by a correspondingly positively engaging connection of the transmission element 9 and coupler 8, the latter can be moved in an engagement movement to the inner differential carrier 4. In the coupling state, torque can be transmitted by the drive gear 3 via the inner differential carrier 4 to the bevel differential side gears 5, the bevel differential pinion gears 6 and, therefore, to the output shafts 18, or vice versa.

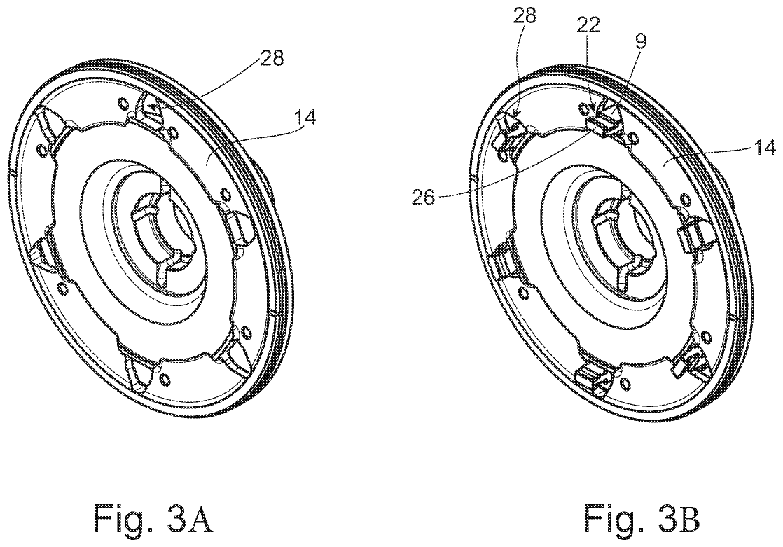

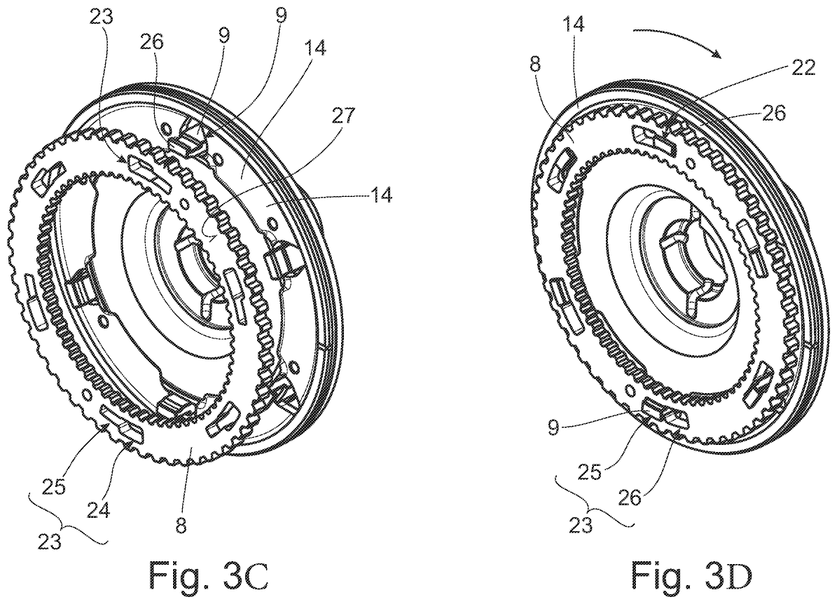

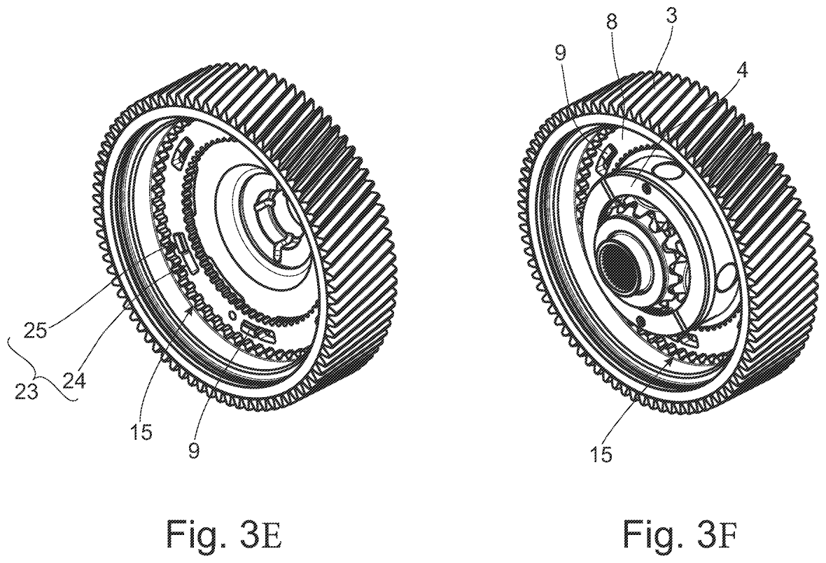

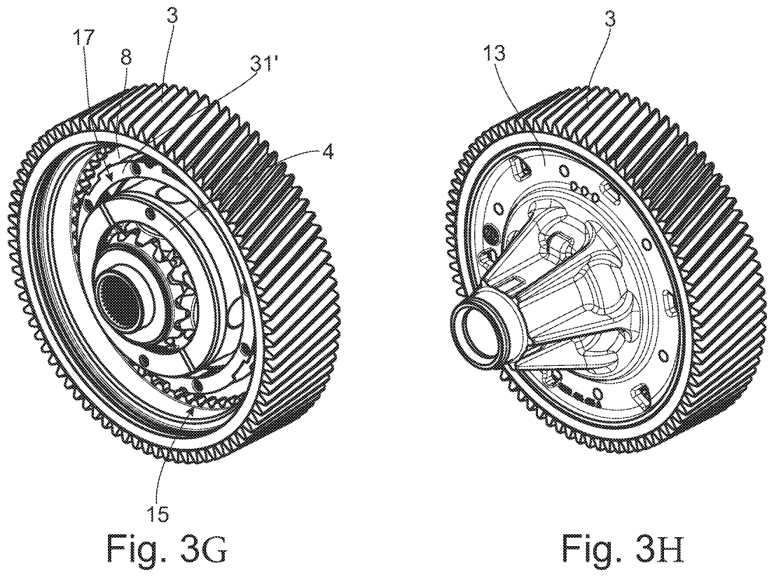

The actuating device 7 comprises transmission element 9, which are adapted to transmit an actuating force 11, represented here by an arrow, which is applied to the transmission element 9 by an actuator 10, to the coupler 8 for carrying out a coupling movement and/or decoupling movement of the coupler 8. The transmission element 9 are connectable or are connected to the coupler 8 by a bayonet closure. FIGS. 3a to 3i are, in part, the assembly steps for assembling an exemplary coupling device 2. The method step of connecting the coupler 8 to the transmission element 9 and, therefore, carrying out the bayonet connection will be apparent when FIGS. 3b to 3d are viewed in conjunction. Accordingly, a portion of the transmission element 9 extends into openings 28 of the outer differential carrier 14 (cf. FIG. 1) by a linear feed movement. Specifically, an engaging part 21 of the transmission element 9 can extend through the openings 28, for example, so that the contact region 22 of the transmission element 9, particularly of the engaging part 21, projects out (cf. FIG. 3b) at the end of the outer differential carrier 14 at which the engaging part 21 exits. It will be seen that the engaging part 21 or the contact region 22 has a groove which, for example, can be adapted, particularly can correspond, in size, e.g., with respect to its axial extension (parallel to the rotational axis 19 of the drive gear), to the size of a corresponding contact portion (e.g., thickness) of the coupler 8.

FIG. 3c shows annular coupler 8. The coupler 8 have receiving portions 23 formed in particular as recesses for receiving the engaging part 21 projecting from the outer differential carrier 14. These receiving portions 23 can have, in each instance, at least two interior spaces, namely, a plug-in region 24 and a closure region 25 directly adjoining the plug-in region. The plug-in region 24 serves for the insertion of the engaging part-side contact region 22 and the closure region 25 serves for receiving the engaging part-side contact region 22 in a frictionally engaging and/or positively engaging manner. The insertion into the plug-in region 24 can be carried out by a linear, particularly an exclusively linear, plug-in movement 29 between the transmission element 9 and the coupler 8. The closure movement 30 can preferably be carried out by an exclusively rotational relative movement of the transmission element 9 and coupler 8. The transmission element 9 and the coupler 8 are preferably formed in such a way that the plug-in movement 29 is carried out along a line which is oriented parallel to the rotational axis of the closure movement 30. In FIG. 3c, plug-in regions 24 are oriented to be in registration with the engaging parts 21 so that the plug-in movement 29 can be carried out proceeding from FIG. 3c. In FIG. 3d, the plugged-together coupler 8 and transmission element 9 have already been rotated relative to one another (closure movement 39) so that the contact regions 22 have been moved into the closure region 25 and, by the protuberances 26, there is a positive engagement between the coupler 8 and the transmission element 9 which prevents an axial movement.

FIG. 3i shows the coupling device 2 from a different side than that depicted in FIGS. 3a to 3h. In this case, the annular portion 20 of the transmission element 9 can be seen. The annular portion 20 can have the shape of a closed ring with a constant distance (radius) from the center of the transmission element 9. The engaging parts 21 adjoin so as to protrude at right angles from the annular portion and, therefore, so as to extend parallel to the rotational axis 19 of the drive gear 3.

The coupler 8 are formed in a disk-like and ring-like manner in the embodiment form shown in FIG. 3c. A toothing for engagement with a drive gear 3, particularly with an inner toothing 15 of the drive gear 3, is formed at an outer lateral surface, and a toothing for engagement with the inner differential carrier 4, particularly with an outer toothing of the inner differential carrier 4, is formed at an inner lateral surface.

The annular portion 20 and the engaging part 21, particularly the annular portion 20 and the protuberance 26 of the engaging part 21, can be formed in one piece, for example (cf. FIGS. 1 and 2). Accordingly, the transmission element 9 can be produced, for example, as a metal or plastic cast component part or injection molded component part.

The movement exerted on the coupler 8 by the actuator 10 via the transmission element 9 can be carried out, for example, against a spring force which is transmitted, in particular directly transmitted, to the coupler 8 by a spring unit 17. Accordingly, an engaging movement or disengaging movement of the coupler 8 can be supported by the spring unit 17. The spring unit 17 can be arranged or arrangeable in such a way that the spring unit 17 prevents or impedes a relative movement, particularly a relative rotational movement, between the coupler 8 and the transmission element 9. Due to the resulting pressing force proceeding from the spring unit 17, the coupler 8 and transmission element 9 can be pressed against so that an increased friction resistance would have to be overcome or, in other words, an increased frictional force would have to be applied, for a relative movement of the coupler 8 and transmission element 9.

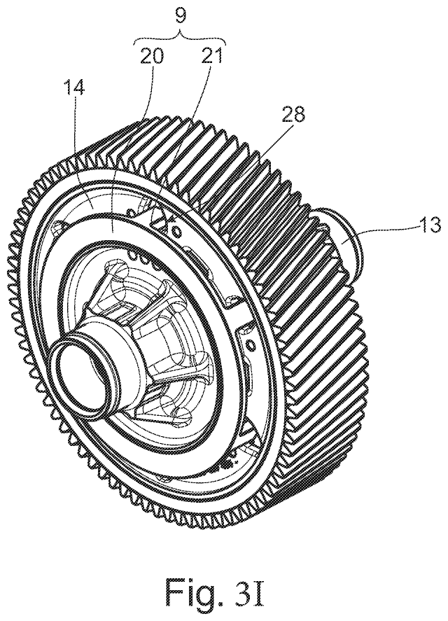

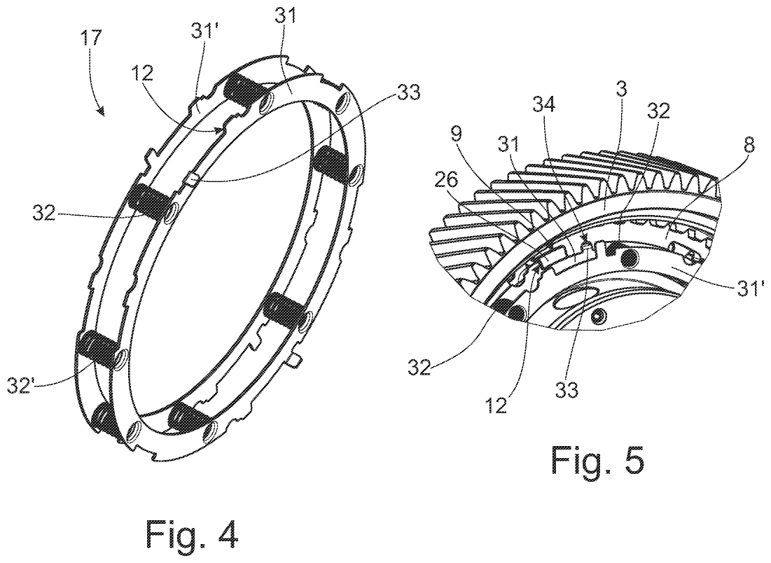

The spring unit 17 is illustrated in isolation in FIG. 4. It can be seen that the spring unit 17 is formed from two spring carriers 31, 31′ oriented parallel to one another. The two spring carriers 31, 31′ are preferably positioned coaxial to one another. Spring elements 32, 32′ which are formed in particular as coil springs are arranged or formed between the spring carriers 31, 31′. Together with the spring elements 32, 32′, the spring carriers 31, 31′ form a mounting assembly which can be fitted or installed as a unit in the coupling device 2. To this end, the spring elements 32, 32′ can be connected to the spring carriers 31, 31′ in a frictionally engaging and/or positively engaging and/or material bonding manner. The spring elements 32, 32′ are oriented parallel to one another, the longitudinal axis of the spring elements 32, 32′ being oriented at right angles to the main extension plane of the spring carriers 31, 31′.

It is further apparent from FIG. 4 that at least one spring carrier 31, 31′ has an engagement portion, particularly an engagement portion extending at right angles to the main extension plane of the spring carrier 31, 31′. In the depicted embodiment form, the spring carrier 31 which is formed as a sheet metal component part has a bent tab 33 which engages in a mating portion, in this instance, for example, a recess 34 of the coupler 8, in the final assembly condition (cf. FIG. 5). Due to the cooperation of the engagement portion and mating portion, the spring unit 17, particularly the spring carrier 31, and the coupler 8 are fixed with respect to rotation relative to one another. Insofar as the spring unit 17 is fitted to the coupler 8 after the closure movement 30 of the bayonet movement is carried out, a rotation of the engaging part 21, particularly the protuberance 26, by the closure region 25 into the plug-in region 24 can be prevented by a correspondingly formed abutment region (e.g., stop 12) between the engaging part 21, particularly the protuberance 26, and the spring unit 17, particularly the spring carrier 31. In other words, the spring unit 17 can be formed in such a way that it prevents an opening of the bayonet connection of the coupler 8 and transmission element 9 in the final assembly condition. For example, a stop 12 for preventing a rotational movement between the coupler 8 and the transmission element 9 can be formed at at least one spring carrier 31, 31′. It is further apparent from FIG. 5 that the actuating device 7, particularly the coupler 8 and the spring unit 17, is arranged at least partially, particularly completely, inside of the drive gear 3. In particular, the spring unit 17 can be received completely inside of an interior space of the drive gear 3.

Further, as can be seen from FIG. 4, it can be provided that the two spring carriers 31, 31′ are formed as nonvariable parts, and there can be a difference, particularly a sole difference, in the configuration of an engagement area, particularly in a bent tab 33. This engagement area can be additionally carried out after a production of the spring carriers 31, 31′ to form this difference, particularly this sole difference, prior to assembly. Accordingly, in the depicted embodiment form, the tab 33 can initially be retained at the two spring carriers 31, 31′, but this tab 33 is bent up only at the first spring carrier 31; the correspondingly retained tab at the further spring carrier 31′ is not bent up and, therefore, is retained, in particular without function. Analogously, the spring carrier 31′ can have a stop shape which has no function in the intended use of the spring unit 17 but is preserved for procuring a nonvariable part for the two spring carriers 31, 31′.

It can be seen from FIG. 3d that the protuberance 26 of the engaging part 21 of the contact region 22 abuts a surface 27 of the coupler 8 remote of the actuator 10 in the final assembly condition.

The method for assembling a coupling device 2 described herein has the following method steps: (a) putting together the transmission element 9 and the coupler 8 and subsequently (b) carrying out a relative rotational movement of the transmission element 9 and coupler 8 to bring about a positively engaging connection after putting them together. Corresponding to the exemplary time sequenced assembly steps shown in FIGS. 3a to 3i, an outer differential carrier 14 is initially provided (FIG. 3a) and the engaging parts 21 of the transmission element 9 are then inserted through the apertures or through the openings 28 of the outer differential carrier 14 (FIG. 3b). The coupler 8 are then linearly fitted (plug-in movement 29) in such a way that the contact region 22 of the engaging part 21 is inserted through the plug-in region of the receiving portion 23 of the coupler 8 (cf. FIG. 3c). Subsequently, a rotation (closure movement 30) is carried out such that the contact region is changed from the plug-in region 24 to the closure region 25 (cf. FIG. 3d). The drive gear 3 is subsequently slid onto the outer lateral surface of the coupler 8 and on the outer lateral surface of the outer differential carrier 14. In so doing, an inner toothing 15 of the drive gear 3 meshes with a corresponding outer toothing of the coupler 8 (cf. FIG. 3e).

In the next step, the inner differential carrier 4 is fitted to or inserted in the coupler 8 in such a way that an outer toothing 16 of the inner differential carrier 4 meshes with a corresponding inner toothing of the coupler 8 and is accordingly brought into torque-transmitting engagement (cf. FIG. 3f). The spring unit 17 is then assembled or applied. This spring unit 17 can be fitted to the coupler 8 in such a way that an engagement area, e.g., a tab 33, is received in a corresponding mating area so that the coupler 8 and spring unit 17 are fixed with respect to rotation relative to one another by positive engagement (cf. FIGS. 3g and 5). Lastly, an outer differential receptacle 13 is fitted to the drive gear 3. The outer differential receptacle 13 preferably contacts the spring unit 17 in such a way that the spring unit 17 is arranged directly between the outer differential receptacle 13 and the coupler 8.

The outer differential carrier 14 and/or the outer differential receptacle 13 can be connected, for example, with the drive gear 3, in particular directly, by material bond and/or frictional engagement and/or positive engagement. Accordingly, it is possible that the outer differential carrier 14 and/or the outer differential receptacle 13 are/is directly welded to the drive gear 3.

The coupling device 2 described herein can be installed in a transmission device 1, particularly a differential. The transmission device 1 can be used in a motor vehicle (not shown).

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A coupling device for a differential of a motor vehicle, comprising:
a drive gear;
at least one bevel differential side gear;
at least one bevel differential pinion gear;
an inner differential carrier which at least partially surrounds the at least one bevel differential side gear and the at least one bevel differential pinion gear;
a coupler configured as a sliding sleeve;
an actuating device configured to:
move the coupler into a coupling state to couple the inner differential carrier with the drive gear, and
move the coupler into a decoupling state to decouple the inner differential carrier from the drive gear; and
an actuator that transmits an actuating force applied to a transmission element of the actuating device to the coupler to carry out a coupling movement and/or uncoupling movement of the coupler,
wherein the transmission element is connectable or is connected to the coupler by a bayonet closure.

16. The coupling device according to claim 15, wherein the actuator is configured to move the transmission element parallel to a rotational axis of the drive gear and/or parallel to a rotational axis of the inner differential carrier to move the coupler into the decoupling state and/or into the coupling state.

17. The coupling device according to claim 15, wherein the transmission element has an annular portion and an engaging part which extend at right angles to a main extension plane of the annular portion, wherein the engaging part has at its end region remote of the annular portion, at its distal end, a contact region for contacting the coupler.

18. The coupling device according to claim 17, wherein the coupler has a receiving portion in which or at which the contact region on an engaging part side is received and/or receivable.

19. The coupling device according to claim 18, wherein the receiving portion is formed as a receiving recess, wherein the receiving recess has a plug-in region for an insertion of an engaging part-side of the contact region and a closure region for receiving the engaging part-side of the contact region in a frictionally engaging and/or positively engaging manner.

20. The coupling device according to claim 15, wherein the coupler is disk-shaped and/or ring-shaped manner, wherein a toothing for engaging with a drive gear is arranged or formed at an outer lateral surface and/or a toothing for engaging with the inner differential carrier is arranged or formed at an inner lateral surface.

21. The coupling device according to claim 17, wherein the contact region of the engaging part has a protuberance that abuts a surface of the coupler remote of the actuator in a final assembly condition.

22. The coupling device according to claim 17, wherein the transmission element is formed in one piece, wherein the annular portion and the engaging part are formed integrally.

23. The coupling device according to claim 15, wherein movement conveyed to the coupler by the actuator via the transmission element is carried out against a spring force which is transmitted to the coupler by a spring unit.

24. The coupling device according to claim 23, wherein the spring unit is arranged or arrangeable such that the spring unit prevents or impedes a relative movement between the coupler and the transmission element.

25. The coupling device according to claim 15, wherein the actuating device is arranged inside of the drive gear.

26. The coupling device according to claim 23, wherein the spring force is directly transmitted to the coupler by the spring unit.

27. The coupling device according to claim 24, wherein the relative movement is a relative rotational movement between the coupler and the transmission element.

28. The coupling device according to claim 23, wherein the coupler and/or the spring unit are arranged inside of the drive gear.

29. A method for assembling a coupling device having a drive gear and an inner differential carrier which at least partially surrounds at least one bevel differential side gear and at least one bevel differential pinion gear, wherein an actuating device is configured to move coupler into a coupling state by the actuating device to couple the inner differential carrier with the drive gear and to move the coupler into a decoupling state by means of the actuating device in order to decouple the inner differential carrier from the drive gear, herein the actuating device comprises a transmission element adapted to transmit an actuating force applied to the transmission element by an actuator to the coupler for carrying out a coupling movement and/or uncoupling movement of the coupler, wherein the transmission element are connectable or are connected to the coupler by a bayonet closure, comprising:
putting together the transmission element and the coupler; and
carrying out a relative rotational movement of the transmission element and coupler to bring about a positively engaging connection after putting them together.

30. A transmission device, configured as a differential, comprising:
a drive gear;
at least one bevel differential side gear;
at least one bevel differential pinion gear;
an inner differential carrier which at least partially surrounds the at least one bevel differential side gear and the at least one bevel differential pinion gear;
a coupler configured as a sliding sleeve;
an actuating device configured to:
move the coupler into a coupling state to couple the inner differential carrier with the drive gear, and
move the coupler into a decoupling state to decouple the inner differential carrier from the drive gear; and
an actuator that transmits an actuating force applied to a transmission element of the actuating device to the coupler to carry out a coupling movement and/or uncoupling movement of the coupler,
wherein the transmission element is connectable or is connected to the coupler by a bayonet closure.

31. Motor vehicle comprising a transmission device comprising:
a drive gear;
at least one bevel differential side gear;
at least one bevel differential pinion gear;
an inner differential carrier which at least partially surrounds the at least one bevel differential side gear and the at least one bevel differential pinion gear;
a coupler configured as a sliding sleeve;
an actuating device configured to:
move the coupler into a coupling state to couple the inner differential carrier with the drive gear, and
move the coupler into a decoupling state to decouple the inner differential carrier from the drive gear; and
an actuator that transmits an actuating force applied to a transmission element of the actuating device to the coupler to carry out a coupling movement and/or uncoupling movement of the coupler,
wherein the transmission element is connectable or is connected to the coupler by a bayonet closure.
